(19) United States
(12) Patent Application Publication
(10) Pub. No.: US 2014/0258899 A1
(43) Pub. Date: Sep. 11, 2014

(54) MODIFYING NUMERIC VALUES

(71) Applicant: BRIAN MANTUANO, San Marcos, CA (US)

(72) Inventor: BRIAN MANTUANO, San Marcos, CA (US)

(21) Appl. No.: 13/789,400

(22) Filed: Mar. 7, 2013

(51) Int. Cl. G06F 3/0488; G06F 3/0484

(52) U.S. Cl. CPC G06F 3/0488; G06F 3/04842
USPC 715/765

(57) ABSTRACT

A user interface allows numeric values to be modified using a touch screen. A user selects a first digit of a numeric value. A touch input having a magnitude and a direction allows the user to select a second digit. The position of the second digit with respect to the first digit is determined based on the touch input. If the first digit is either the most significant digit or the least significant digit, the second digit corresponds to a new digit introduced adjacent to the first digit. A second touch input is received causing the value of the second digit to be modified. If the second digit value is modified so as to increase above nine or below zero, the value of the second digit wraps around. If the value of the second digit wraps around, the digit adjacent to the second digit may be modified.

### BACKGROUND

1. Field of Art

The disclosure generally relates to user interfaces for touch screens and in particular to user interface for modifying numeric values using a touch screen.

2. Description of the Related Art

User interfaces typically provide mechanisms that allow users to enter or modify data, for example, numeric values. Conventional examples of mechanisms provided by user interfaces for entering data include text-input fields that allow a user to enter values using a keyboard. The user types in the specific value of each character or digit of the data being entered. Some user interfaces allow specification of data values using a drop down list of values. For example, user interfaces may allow a user to enter a date using a drop down list for each of the month, day, and year.

These user interfaces typically require a peripheral device, for example, a mouse or a keyboard to allow the user to enter data. However, several client devices provide a touch screen and may not have a hardware keyboard or mouse. For example, tablets and smartphones offered by several vendors do not provide a hardware keyboard or mouse with the device. For these devices, a user enters or modifies data or values using the touch screen rather than a peripheral device such as keyboard and mouse.

Some applications for touch screen devices provide a simulated keyboard that allows the user to enter values using the touch screen. For example, FIG. 1 shows a simulation of a calculator 100 that can be displayed as a user interface on a computer screen. A user can use the keys 120 of the simulated keypad of the calculator to enter numbers displayed in the text field 110. The user can use a touch screen to click on the simulated keys 120 to enter or modify values displayed in the text field 110.

### SUMMARY

Systems, methods, and computer program products allow entry or modification of numeric values using a touch screen. A user selects a first digit of a numeric value. The user further provides a touch input having a direction and a magnitude for selecting a second digit of the numeric value. The position of the second digit with respect to the first digit is selected based on the direction and magnitude of the touch input. The user provides a second touch input having a direction and a magnitude for modifying the second digit. The value of the second digit is modified based on the direction and magnitude of the second touch input.

In an embodiment, the numeric value is displayed having an orientation on the touch screen. The direction of the first touch input has at least a component parallel to the orientation of the numeric value. The direction of the second touch input has at least a component perpendicular to the orientation of the numeric value. For example, if the numeric value is displayed horizontally, the first touch input has a horizontal component and the second touch input has a vertical component.

If the first digit is either the most significant digit or the least significant digit of the numeric value, the second digit may be introduced as a new digit adjacent to the first digit. If the numeric value is an integer without a decimal point and the first digit is the least significant digit of the numeric value, a decimal point may be introduced between the first digit and the second digit. In an embodiment, the new digit introduced has zero value that may be subsequently modified using the second touch input.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction to the figures is below.

FIG. 1 illustrates a conventional system displaying a user interface allowing a user to enter or modify a numeric value.

FIG. 2 illustrates the system architecture of a device for allowing a user to enter or modify numeric values, in accordance with an embodiment.

FIGS. 3A-3D illustrate selection of a digit of a numeric value and modification of the numeric value based on touch input from a user, in accordance with an embodiment.

FIGS. 4A-4D illustrate selection of a new digit starting from a previously selected digit, in accordance with an embodiment.

FIGS. 5A-5D illustrate introduction of a new digit adjacent to the least significant digit along with a decimal point based on a touch input provided by a user, in accordance with an embodiment.

FIGS. 6A-6B illustrate decrease in the value of a digit causing the digit value to wrap around and modify an adjacent digit, in accordance with an embodiment.

FIGS. 7A-7B illustrate increase in the value of a digit causing the digit value to wrap around and modify an adjacent digit, in accordance with an embodiment.

FIGS. 8A-8B illustrate increase in the value of a digit causing the digit value to wrap around and modify values of multiple digits, in accordance with an embodiment.

FIGS. 9A-9B illustrate modification of the value of a digit based on a touch input causing the digit value to wrap around without affecting any adjacent digits, in accordance with an embodiment.

FIG. 10 shows a flowchart describing an embodiment of the process for allowing a user to enter or modify a numeric value using a touch screen.

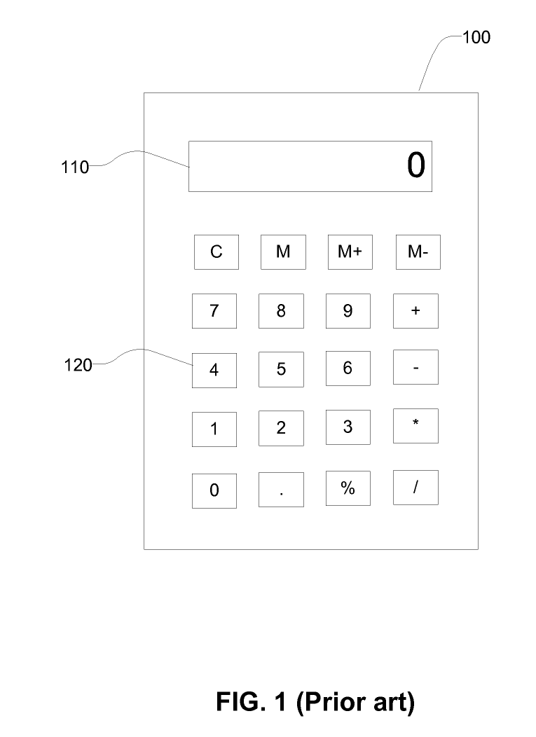

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Architecture

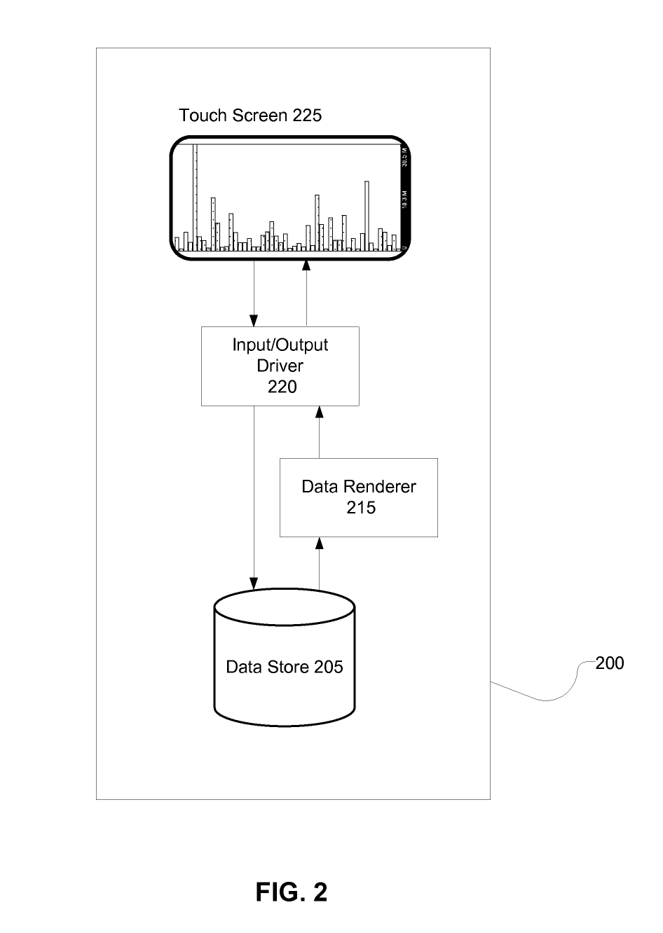

FIG. 2 illustrates the system architecture of a device 200 for allowing a user to enter or modify numeric values, in accordance with an embodiment. The device 200 includes a data store 205, a data renderer module 215, an input/output (driver (10 driver) module 220, and a touch screen 225. As used herein, the term “module” refers to a computer program logic and/or data for providing the specified functionality. A module can be implemented in hardware, firmware, and/or software. Examples of types of devices 200 shown in FIG. 2 include tablet computers, smart phone devices, and mobile phones.

An application may allow a user to read and modify data values stored in the data store 205 by displaying them on the touch screen 225. The application may modify values stored in the memory of the device, for example, random access memory (RAM) or other form of volatile memory. An application may add new values to the data store 205 or modify values previously stored in the data store 205. The data store 205 in one embodiment is implemented using a hard disk drive but can also be implemented using any other device capable of storing data, such as a writeable compact disc (CD) or DVD, or a solid state memory device, for example a flash memory. In other embodiments, the data store 205 may represent RAM.

The data and the information necessary for rendering the data are provided by the data renderer 215 to the input/output driver 220. The input/output driver 220 provides the touch screen 225 with instructions and data necessary for displaying data and/or images. In various embodiments, the touch screen 225 is used to input data and/or commands. For example, a touch sensitive screen can sense the coordinates of the portion of the screen touched by a user. The user may touch the touch screen 225, for example, to select a user interface element, for example, a key of a simulated keyboard. Alternatively, the user may touch the touch screen 225 to select a data element from a list of data elements displayed on the screen. The input/output driver 220 sends the data or instructions provided by the touch screen 225 causing the data stored in the data store 205 to be modified or new data added to the data store 205. In an embodiment, the input/output driver 220 invokes a numeric processor to determine changes to a numeric value to be displayed. The software modules executing on the device that cause changes to numeric values displayed in response to the user input are also referred to herein as the system. For example, a reference to the system modifying a numeric value displayed corresponds to a module modifying the numeric value displayed. The module that causes numeric values displayed to change may be the input/output driver 200 or any other module, for example, a numeric value processing module. In an embodiment, the numeric values displayed may be modified by applications, for example, the user interface of an application. The application may invoke the numeric value processing module to perform the required action.

### Entering/Modifying Numeric Values

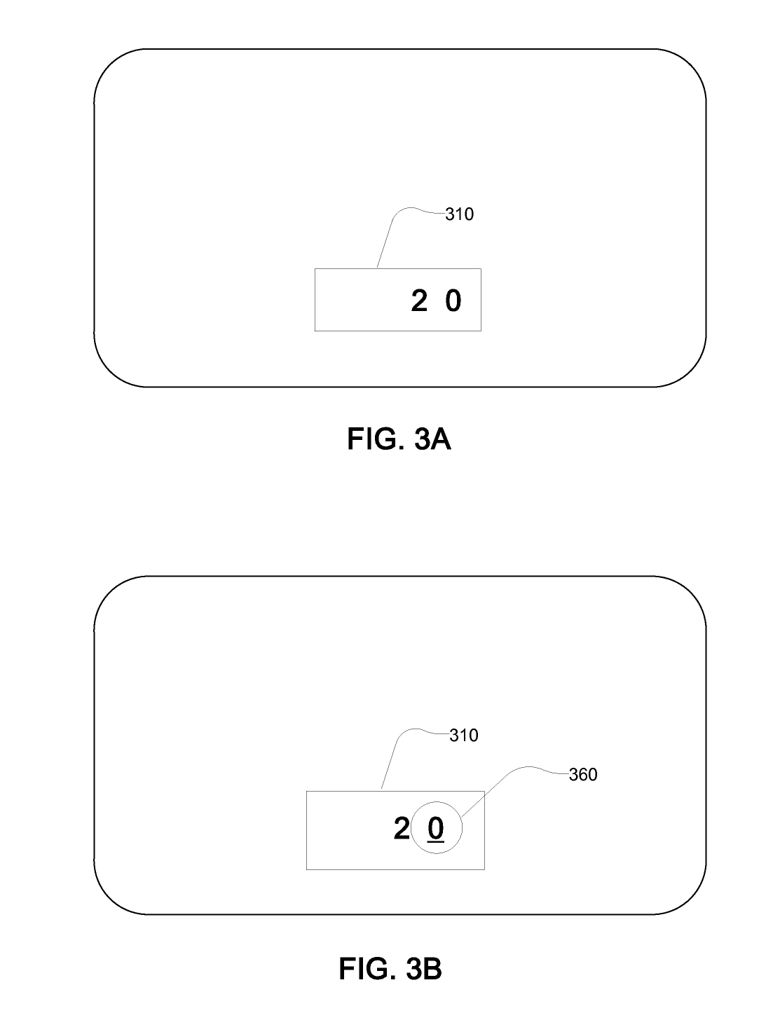

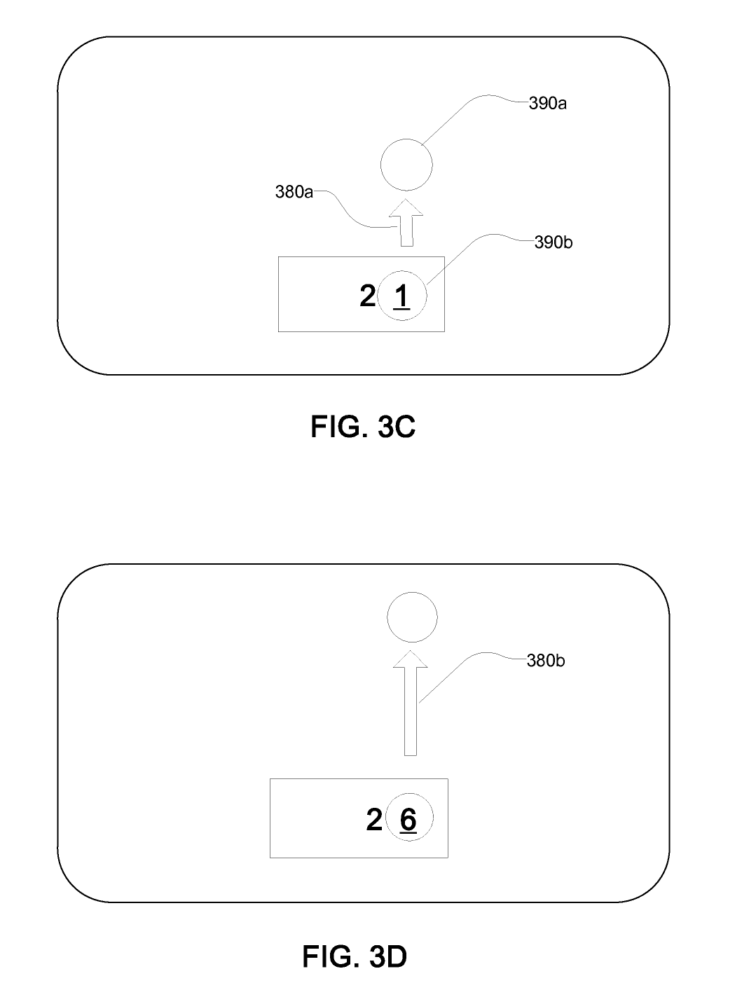

FIGS. 3A-3D illustrate selection of a digit of a numeric value and modification of the numeric value based on touch input from a user, in accordance with an embodiment. FIG. 3 and the other figures use like reference numerals to identify like elements. A letter after a reference numeral, such as “380a,” indicates that the text refers specifically to the element having that particular reference numeral. A reference numeral in the text without a following letter, such as “380,” refers to any or all of the elements in the figures bearing that reference numeral (e.g. “380” in the text refers to reference numerals “380a” and/or “380b” in the figures).

FIG. 3A illustrates a numeric value displayed within a field 310. The numeric value can be displayed in various contexts, for example, as an input field of a user interface, or a data value obtained from a database, or an application displaying a numeric value. Other embodiments can display and modify other types of data values using touch screens for example, alphanumeric values. The field 310 may display a value read from the data store 205. If the user is adding a new value to the data store 205, the field 310 may display the value zero that can be subsequently modified using the touch screen 225.

To modify a particular digit value, the user provides an input to select the digit value. For example, the user may touch a particular digit value or tap on a digit value to select it. FIG. 3A, the user interface field 310 displaying a numeric value 20 having two digits. FIG. 3B shows the system displaying a selected digit in a manner that distinguishes the digit compared to other digits of the numeric value. As shown in FIG. 3B, the digit ‘0’ is selected from the numeric value 20. The system may display the selected digit using a different font compared to other digits, or displayed using a different color compared to other digits of the numeric value, or displayed as flickering. In other embodiments, the system may display the digit underscored or italicized. In yet other embodiments, the system may display a shape 360 around the selected digit for example, a circle or oval. Displaying the digit in a manner that distinguishes the digit compared to other digits allows a user to visualize the digit value that can be modified by providing subsequent touch inputs.

In one embodiment, when the user stops touching the screen, for example, subsequent to invoking the above process for modifying a selected digit, the system displays the selected digit similar to other digits of the numeric value. However, the system stores the position of the selected digit so that the selected digit acts as a basis for a subsequent user input. For example, if the user provides the touch input to select a new digit, the previously selected digit becomes a starting point for determining the next digit. Similarly, if the user provides touch input to modify a selected value, the previously selected value gets modified. The selection of the digit remains active until the user explicitly selects another digit or until more than a threshold time has passed.

FIG. 3C illustrates how a touch input can cause the system to modify the value of the selected digit. The user input provided by the user has a direction and a magnitude. For example, the user can perform a swiping motion, a dragging motion, or a flicking motion. In the following discussion the swiping motion is used for illustrating the user inputs, however, the user input can be any other type of touch input that has a direction and a magnitude.

As shown in FIG. 3C, the system displays the numeric value in a horizontal orientation. The user provides an input that is approximately perpendicular to the orientation of the numeric value on the display screen. In other words, the input has at least a component that is perpendicular to the orientation of the numeric value on the display screen. For example, if the numeric value is displayed in a horizontal orientation, the user input can be in a direction that is predominantly vertical. The system increases the selected digit value responsive to the user input having a first vertical direction, for example, upward direction, and the system decreases the selected digit value responsive to the user input having the opposite vertical direction, for example, downward direction.

The amount by which the system changes the selected value may depend on the magnitude of the user input. For example, if a user swipes a larger distance, the system changes the selected digit by a larger amount as compared to small swiping motion by the user. For example, FIG. 3C shows a small swiping motion represented in the figure by arrow 380a. The arrows 380 shown in FIG. 3 simply represent the swiping motion and may not be displayed on the display screen by the user interface. The circle 390a illustrates a portion of the touch screen that is touched by the user and may not be a shape displayed by the user interface. The circle 390b corresponds to the starting position of a swiping motion. The circle 390a shown as a continuous line corresponds to the end position of a swiping motion. Assuming an upward vertical swiping motion 380a is performed, the swiping motion causes the system to increase the selected digit value from 0 to 1. However, as shown in FIG. 3D, if the user provides a user input with larger magnitude, for example, a longer swiping motion 380b, the system may change the value by a larger amount, i.e., increased from 0 to 6.

In one embodiment, the system does not modify the digit value once the digit value reaches the maximum digit value, i.e., nine, in response to user input that causes the selected digit to increase beyond the maximum value, for example, by using a long swiping motion or by continuing to swipe even after the digit value has reached nine. Similarly, the system does not modify the digit value if it reaches the smallest possible value, i.e., zero and the user provides input that attempts to cause the selected digit to decrease below zero. The maximum or minimum digit value depends on the radix value of the numeric system being used, for example, for a hexadecimal system, the maximum digit value is F and minimum digit value is 0.

In other embodiments, the system wraps around the selected digit and continues to modify the value responsive to user input even if the digit reaches the maximum or the minimum digit value. For example, if the digit value is increased until it reaches nine and the user continues attempting to increase the value, the system wraps around the digit value from nine to zero and continues to change the digit value based on the user input. Similarly, if the user input attempts to cause the system to decrease the selected digit value to a value below zero, the system wraps around the digit value from zero to nine and then continues decreasing the digit value from nine depending on the user input.

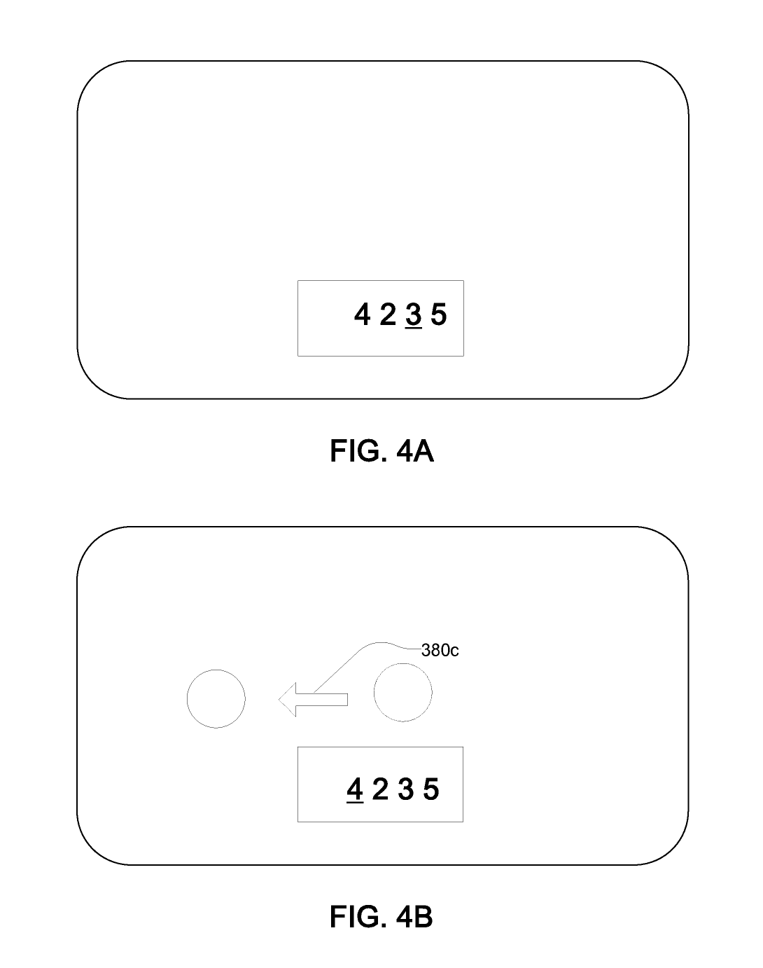

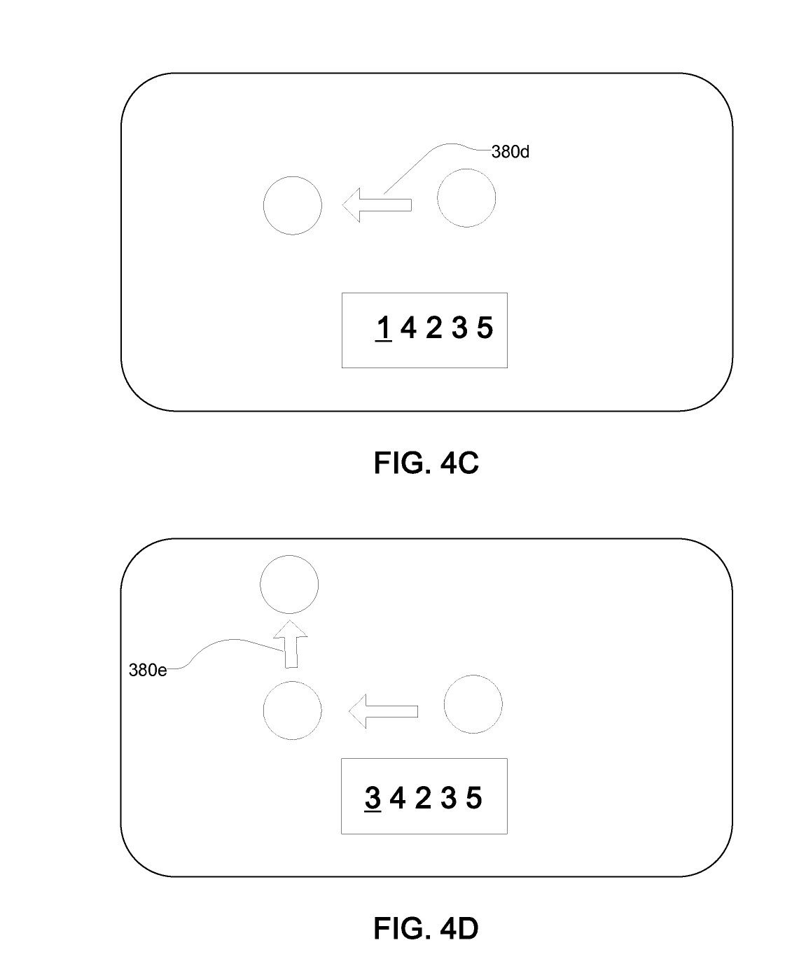

FIGS. 4A-4D illustrate selection of a new digit starting from a previously selected digit, in accordance with an embodiment. As shown in FIG. 4A, the numeric value 4235 is displayed. The digit 5 is in the 1's place, the digit 3 is in the 10's place, the digit 2 is in the 100's place, and the digit 4 is in the 1000's place. The digit in the 10's place having value 3 is selected. The user provides a horizontal touch input having a direction and magnitude causing the system to select another digit. In an embodiment, the touch input that causes a new digit to be selected has a direction having a component that is substantially parallel to the orientation of the numeric value being displayed. For example, FIG. 4B shows arrow 380c that represents a horizontal swiping motion that is parallel to the horizontal orientation of the numeric value.

The relative position of the new selection of the digit with respect to the previous selection of the digit depends on the direction of the touch input. For example, a leftward direction of the swiping motion causes the system to select a digit to the left of the previous digit and a rightward swiping motion causes the system to select a digit to the right of the previous digit.

In an embodiment, the distance between the new selection of digit and the previous selection of digit depends on the magnitude of the touch input. The distance between two digits may be measured in terms of the number of digits between the two digits. If a user provides a small swiping motion, the system selects a digit near the previous selection of digit whereas if a user provides a longer swiping motion, the system selects a digit further from the previous selection of digit.

FIG. 4C illustrates that if the user attempts to select a digit that occurs to the left of the most significant digit, the system adds a new digit to the left of the most significant digit and the new digit is selected. The new digit added may have a default value, for example, 1 or zero. In an embodiment, the default value of the new digit can be configured in the system. The user may attempt to select a digit to the left of the most significant digit by providing a touch input 380d in the direction required to select the most significant digit with a magnitude that is larger than the magnitude required to select the most significant digit. Alternatively, the user can first select the most significant digit and subsequently provide a touch input 380d directed to left. In these situations, the system may add one or more digits, for example, zeroes to the left of the most significant digit. In an embodiment, when the user provides these inputs causing the system to add new digits, the system adds a single zero to the left of the most significant digit irrespective of the magnitude of the touch input. In other embodiments, given these inputs, the number of zeroes added to the left of the most significant digit may depend on the magnitude of the touch input.

In another embodiment, the system adds a single zero responsive to the user input. However, if the user provides a second user input, the system adds a second zero to the left of the first zero. Accordingly, the user can repeatedly provide user input to cause the system to add as many zeros to the left of the most significant digit as desired. The user may select the left most zero and then cause the system to change the value.

As illustrated in FIG. 4D, the user can further provide touch input to cause the system to modify the value of the new digit that is added. For example, if the user provides an upward swiping motion as represented by arrow 380e, the system increases the value of the new digit based on the magnitude of the upward swiping motion. If the user provides a downward swiping motion, the system wraps around the value of the new digit since zero is the smallest digit value. As a result, the system changes the left most zero to nine and then continues to decrease the digit value based on the magnitude of the swiping motion.

In another embodiment, responsive to the user attempting to decrease the value of the new digit that occupies the most significant digit position, the system changes the numeric value to a negative value. In this situation, instead of the most significant digit value wrapping around, the system changes the digit value from zero to one and keeps increasing the digit value. However, since the overall numeric value is changed to be negative, this corresponds to the overall numeric value decreasing, i.e., increasing magnitude of a negative number.

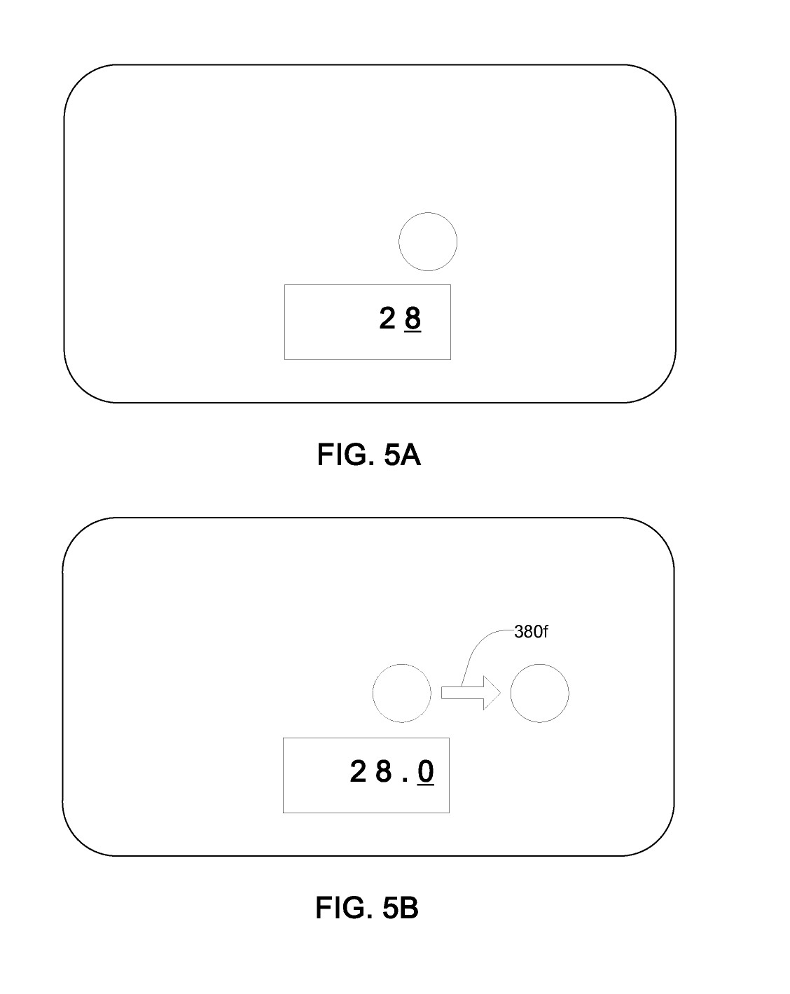

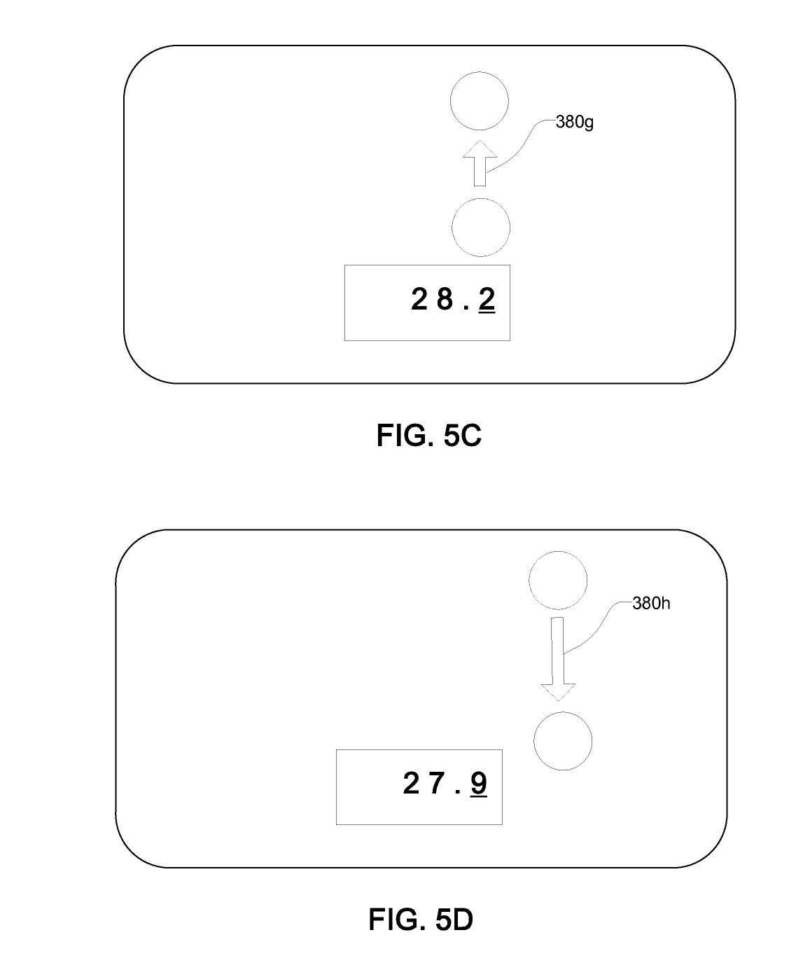

FIGS. 5A-5D illustrate introduction of a new digit adjacent to the least significant digit along with a decimal point based on a touch input provided by a user, in accordance with an embodiment. If the selected digit is the least significant digit and the touch input is a swiping motion 380f to the right, the system adds a new digit to the right of the least significant digit, for example, a digit with zero value or a digit having a default value that can be configured. If the numeric value currently displayed is an integer value with no decimal point, the system adds a decimal point between the previously selected digit and the new digit that was added. As illustrated in FIG. 5A-B, the system modifies the numeric value 28 to the value 28.0 as a result of the touch input 380f. In an embodiment, the system may determine the number of zeroes introduced to the right of the decimal point based on the magnitude of the touch input. In other embodiments, the system may add a single zero digit to the right of the decimal point irrespective of the magnitude of the touch input. Techniques discussed above for adding zeros to the left of the most significant digit are applicable here for adding zeros to the right of the least significant digit.

As illustrated in FIG. 4C, once the system adds a zero digit to the right of the decimal point responsive to the user input, the user can use a vertical touch input to cause the system to modify the digit value, for example, increase the digit value by an upward swiping motion 380g. The user can also use a downward swiping motion to cause the system to reduce the digit value, for example, as shown in FIG. 4D. As shown in FIG. 4D, if the digit value is decreased to zero, the system may wrap around the digit value to nine and then continue decreasing the digit value based on the touch input. Furthermore, if the system decreases the selected digit value below zero by wrapping around, the digit value adjacent to the selected digit may also decrease. For example, as shown in FIG. 4D, since the user input causes the system to decrease the least significant digit value to a value below zero, the least significant digit wraps around to digit value nine, and the digit adjacent to the selected digit to its left is reduced from 8 to 7, resulting in the numeric value dropping from 28.2 to 27.9.

In some embodiments, the numeric value may be configured not to change from integer to a floating point value. In these embodiments, the swiping motion 380f to the right causes the system to add one or more zeroes to the right of the least significant digit without introducing a decimal point. For every zero digit that is added to the right of the least significant digit, the system increases the overall numeric value by a power of ten.

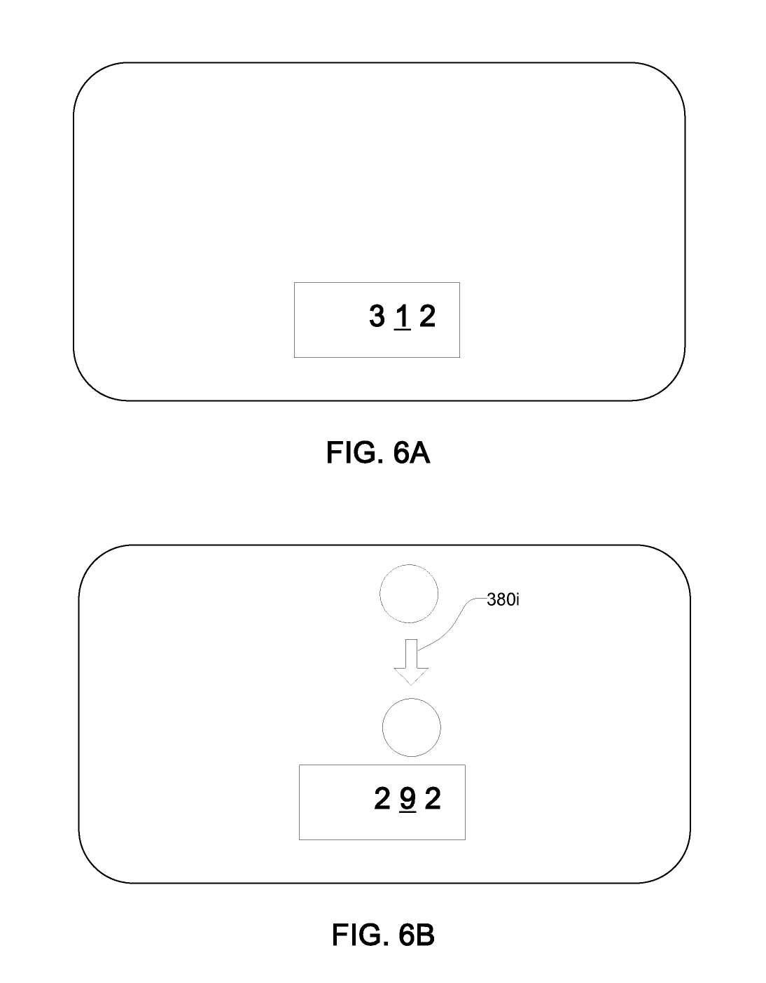

The user can select any digit in a given numeric value and provide touch input causing the system to modify the selected value. FIGS. 6A-6B illustrate decrease in the value of a digit below zero based on a touch input causing the system to wrap around the digit value and modify an adjacent digit, in accordance with an embodiment. As selected in FIG. 6A, the digit 1 from the numeric value 312 is selected. The user provides a touch input corresponding to a downward swiping motion 380i causing the system to decrease the selected digit. As shown in FIG. 6B, the selected digit value wraps around and reaches nine. Furthermore, as the selected digit value wraps around, the system modifies the digit adjacent to the selected digit, causing it to change value from 3 to 2. As a result, the numeric value decreases from 312 to 292. Note that the vertical touch input, i.e., upward or downward swiping motion may affect one or more digits to the left of the selected digit when the selected digit wraps around but does not affect the digits to the right of the selected digits.

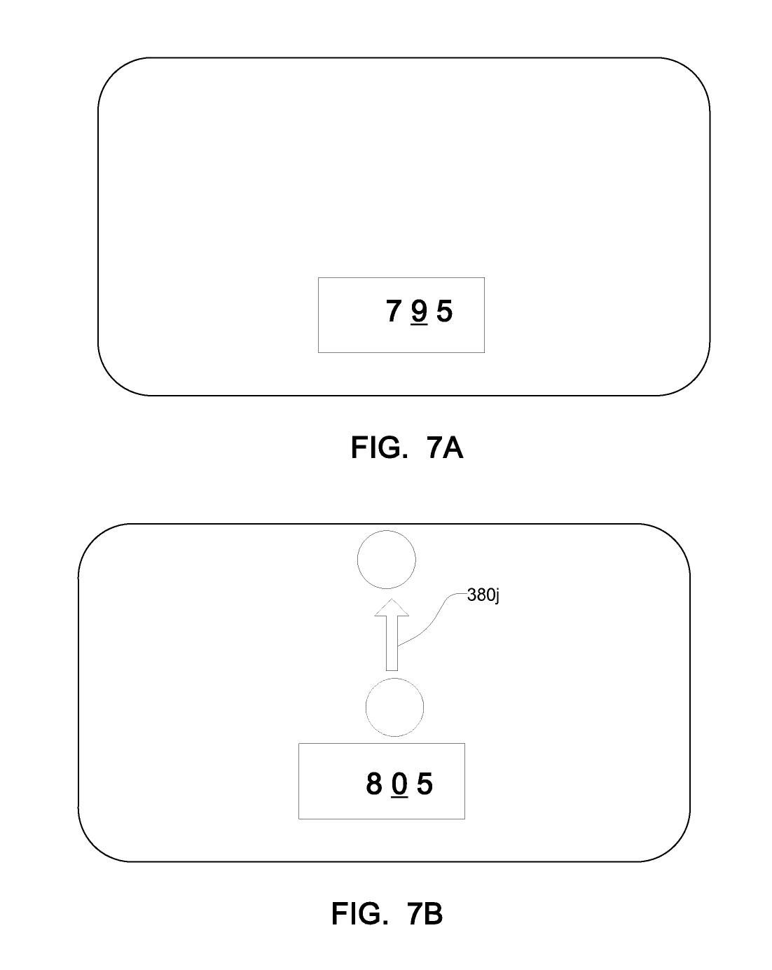

FIGS. 7A-7B illustrate increase in the value of a digit above nine based on a touch input causing the digit value to wrap around and modify an adjacent digit, in accordance with an embodiment. As shown in FIG. 7A, the middle digit having value 9 is selected from the number 795. As shown in FIG. 7B, the upward swiping motion 380j causes the system to increase the digit value. The system wraps around the digit value to zero since the digit value is already at the maximum digit value of 9. This causes the system to increase the digit value to the left of the selected digit from 7 to 8. Accordingly the system increases the numeric value 795 to 805. In some situations, the system may modify more than one digit to the left of the selected digit.

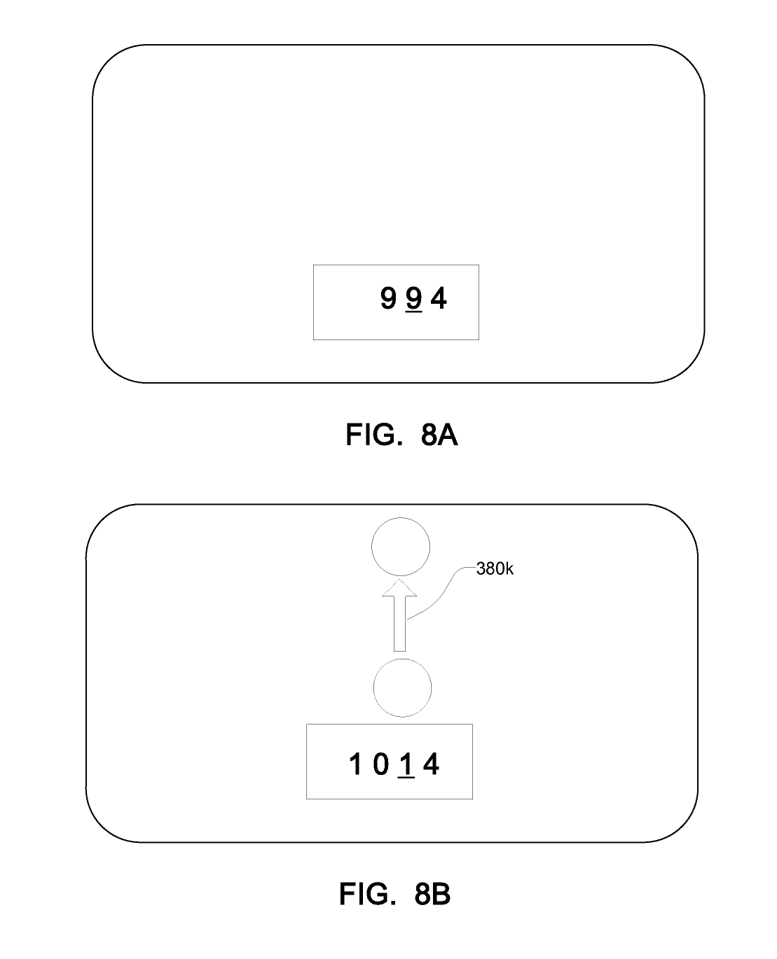

FIGS. 8A-8B illustrate increase in the value of a digit above nine based on a touch input causing the system to wrap around the digit value and modify values of multiple digits, in accordance with an embodiment. As shown in FIG. 8A, the middle digit 9 from numeric value 994 is selected. The touch input corresponding to an upward swiping motion 380k causes the system to wrap around the digit value to 0 and then increase the digit value to 1. This causes the system to increase the digit value adjacent to the selected digit to the left. Since the digit adjacent to the selected digit and to its left is also 9, the adjacent digit also wraps around to 0. Furthermore, the system adds a new digit having value 1 to the left of the most significant digit. As a result, the system changes the numeric value 994 to 1014. Accordingly, a change of a value of a selected digit an cause an adjacent value to the left of the selected digit to be modified resulting in a ripple effect causing other digits to the left of the selected digits to be modified. In some situations, the most significant digit value may be affected, resulting in either the system adding a new digit to the left of the most significant digit, or to remove the most significant digit from the numeric value. For example, if the numeric value is 100 and the user selects the least significant digit and causes the system to reduce it by 1, the system removes the most significant digit having value 1 and changes the numeric value to 99.

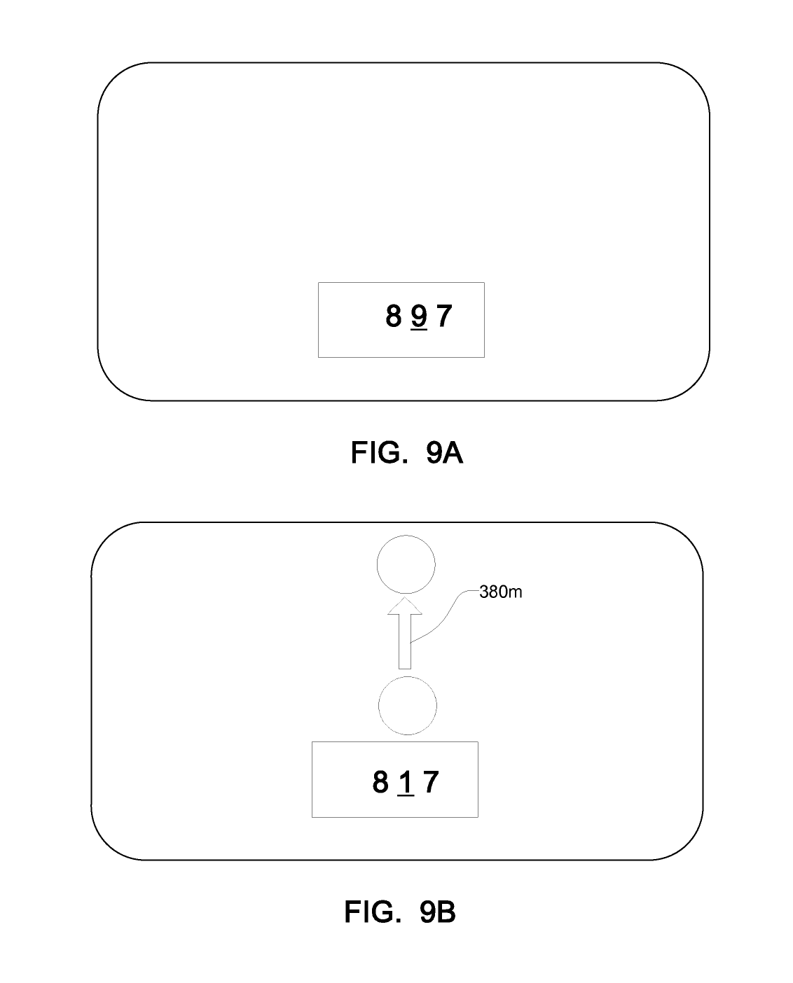

In some embodiments, the user input causes the system to change a digit's value independent of the other digit values. For example, even if a digit value is modified causing the value to wrap around, the system does not change the digit adjacent to the selected digit. FIGS. 9A-9B illustrate modification of the value of a digit based on a touch input causing the digit value to wrap around without affecting any adjacent digits, in accordance with an embodiment. As shown in FIG. 9A, the user selects the middle digit of 897 having value 9. The user provides touch input corresponding to an upward swiping motion 380m causing the system to wrap around the selected digit value to 0 and then increase the digit value to 1. However, the digit value 8 adjacent to the selected digit and to its left is not affected and stays at its original value of 8. Similarly, if the user attempts to decrease a selected digit below zero, the system wraps around the selected digit to 9 and continues to decrease the digit value, however the digit to the left of the selected digit is unaffected. If the user wants to change the adjacent digit value, the user must select that particular digit and provide input to cause the system to change it to the desired value.

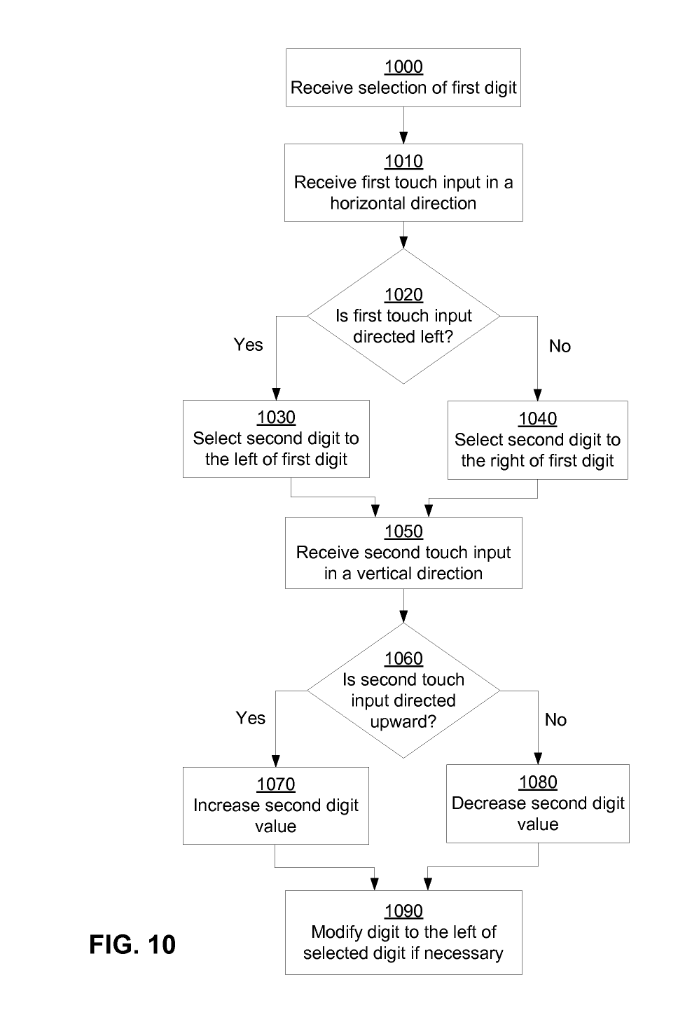

FIG. 10 shows a flowchart describing an embodiment of the process for allowing a user to enter or modify a numeric value using a touch screen. The flowchart shown in FIG. 10 assumes that the numeric value is displayed in a horizontal orientation. If the orientation of the numeric value is different, the directions of the touch input need to be changed appropriately. The system receives 1000 a selection of the first digit from a numeric value that is displayed. The system further receives a first touch input in a horizontal direction. The first touch input has a direction and a magnitude. As mentioned above, if the numeric value has an orientation different from horizontal, the first touch input must have a substantial component parallel to the direction of orientation of the numeric value. Although, the flowchart illustrated in FIG. 10 shows the first touch input as horizontal and the second touch input as vertical, the user can provide the inputs in any order. For example, a user can provide the first tough input as vertical and second as horizontal, or multiple touch inputs in different combinations.

The system checks 1020 if the first touch input is directed toward left. If the first touch input is directed towards left, the system selects 1030 a second digit to the left of the first digit. If the first touch input is not directed towards left, i.e., the first touch input is directed towards right, the system selects 1040 a second digit to the right of the first digit. If necessary, a new digit may be added to left or right of the numeric value and then selected 1030, 1040.

A second touch input is received that is substantially in a vertical direction. The second touch input has a direction and a magnitude. As mentioned above, if the numeric value has an orientation different from horizontal, the second touch input must have a substantial component perpendicular to the direction of orientation of the numeric value. The system checks 1060 if the second touch input is directed upwards. If the second touch input is directed upwards (or a preconfigured direction with respect to the orientation of the numeric value), the second digit value is increased 1070 based on the magnitude of the second touch input. If the second touch input is not directed upwards, i.e., it is directed downwards, the second digit value is decreased 1080 based on the magnitude of the second touch input. The second digit value may wrap around if it is increased beyond the maximum digit possible, i.e., nine, or if it is decreased below the minimum digit possible, i.e., zero. In an embodiment, the modification of the second digit causes the digit values adjacent to the second digit and to the left of the second digit to be modified 1090. The modification of digit adjacent to the second digit may trigger modification of subsequent digits to the left of each modified digit. This may ultimately result in a new digit being added adjacent to the most significant digit or the most significant digit being removed.

In one embodiment, the user selects one of the displayed digits and provides a user input that causes the system to zero out all digits that are less-significant than the selected digit. For example, the user may touch a digit displayed on the screen to select the digit and then provide a shake input. In another embodiment, the shake input itself is performed on a digit, thereby combining the step of selecting and shaking in a single operation, i.e., the shake operation. The user input, for example, the shake input causes the system to change the value of each digit that is less-significant than the selected digit to zero.

For example, if the numeric value displayed is 42356 and the user selects digit 2 and provides the user input, the system changes the numeric value to 42000 since 3, 5, and 6 are digits that are less significant that digit 2 in 42356. These embodiments allow the user to remove clutter in a numeric value by reducing less-significant digits to zero without having to change the values of the digits to zero one by one.

As an example, the user input provided for zeroing out all less significant digit is a shake. For example, the user may select the digit and shake the digit up and down. The shake input may be provided by the user by rapidly moving the users finger on a touch screen or by rapidly moving a pointing device back and forth, i.e., in a first direction followed by a second direction opposite the first direction and repeating the movement in rapid succession. In an embodiment, the shake input is along a direction that is approximately perpendicular to the orientation of the numeric value as displayed on the screen. That is, the shake input is along a direction that has at least a component along the direction perpendicular to the orientation of the numeric value as displayed on the screen.

In another embodiment, the user input associated with a selection of a digit causes the system to round off the numeric value at the selected digit. For example, if the input numeric value is 42998 and the user shakes the digit 2, the system changes the numeric value to 43000. Accordingly, the selected digit is rounded off to the nearest value based on the value of the less-significant digits. In an embodiment, if the value of the less-significant digit adjacent to the selected digit is greater than or equal to 5, the system increases the value of the selected digit by one responsive to the shake input as all less-significant digits are zeroed out. On the other hand, if the value of the less-significant digit adjacent to the selected digit is less than 5, the system keeps the value of the selected digit the same responsive to the shake input as all less-significant digits are zeroed out.

The functionality of rounding off a numeric value may be provided along with the other functionality described herein. This is ensured by associating each particular type of user input in a given context with a unique functionality. In an embodiment, the type of user input used to zero out digits may be configurable. Accordingly, a user may configure the system to use any user input that is not being used for another purpose for zeroing out digits in a number.

Embodiments disclosed herein allow numeric values to be added or modified using touch screens. However, the techniques disclosed can be applied to other types of data values, for example, alphanumeric values. Although examples disclosed herein display numbers having a radix ten, the techniques disclosed apply to other types of numeric values, for example hexadecimal, binary, octal or any other representation of numeric value that uses positional significance of digits. The techniques disclosed herein apply to any system of representing data values that applies positional significance to individual characters representing a data value. If a system represents data values such that the most significant digit value is the rightmost digit, the least significant digit value is the leftmost digit, and the positional significance decreases as one goes from right to left within a data value, the techniques disclosed herein can be applied with appropriate modification of the effects of user inputs as may be necessary. For example, a left swiping motion may result in addition of a decimal point to the left of the data value, if the system allows such a representation. Similarly, increasing or decreasing a selected digit value may cause digits to the right of the selected digit to be affected.

It is to be understood that the Figures and descriptions of the present invention have been simplified to illustrate elements that are relevant for a clear understanding of the present invention, while eliminating, for the purpose of clarity, many other elements found in a typical system that allows modification of numeric values. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for entering or modifying numeric values through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for modifying numeric values via a touch screen, the method comprising:
displaying, by a computer, a numeric value on a touch screen, the numeric value having a plurality of digits;
receiving a first touch input having a direction and a magnitude, the first touch input associated with a first digit of the numeric value;
responsive to receiving the first touch input, selecting a second digit of the numeric value, wherein a relative position of the second digit with respect to the first digit is determined based on the magnitude and direction of the first touch input;
receiving a second touch input having a direction and a magnitude; and
responsive to receiving the second touch input, modifying the value of the second digit based on the second touch input.

2. The method of claim 1, wherein selecting the second digit comprises:
determining a significance of the second digit as compared to a significance of the first digit based on the direction of the first touch input.

3. The method of claim 1, wherein selecting the second digit comprises:
determining a distance between the second digit and the first digit based on the magnitude of the first touch input.

4. The method of claim 1, wherein selecting the second digit comprises:
responsive to the first digit being a least significant digit of the numeric value, introducing the second digit as a new least significant digit to the right of the first digit.

5. The method of claim 1, wherein selecting the second digit comprises:
responsive to the first digit being a most significant digit of the numeric value, introducing the second digit as a new most significant digit to the left of the first digit.

6. The method of claim 1, wherein modifying the second digit comprises increasing the second digit value responsive to the second touch input having a first direction and decreasing the digit value responsive to second touch input having a direction opposite the first direction.

7. The method of claim 6, wherein modifying the second digit comprises wrapping around the second digit value responsive the magnitude of the second touch input causing the second digit to perform one of: increase above nine or decrease below zero.

8. The method of claim 7, wherein responsive to wrapping around the second digit value, keeping a digit value to the left of the second digit value unchanged.

9. The method of claim 7, wherein responsive to wrapping around the second digit value, modifying the digit value to the left of the second digit value, comprising:
responsive to the second touch input causing the second digit to increase above nine, incrementing the digit to the left of the second digit.

10. The method of claim 7, wherein responsive to wrapping around the second digit value, modifying the digit value to the left of the second digit value, comprising:
responsive to the second touch input causing the second digit to decrease below zero, decreasing the digit value to the left of the second digit value.

11. The method of claim 1, wherein selecting the second digit of the numeric value comprises selecting a digit obtained by travelling in the direction of the first input from the first digit.

12. The method of claim 1, wherein the selecting of the second digit value is performed responsive to the first touch input having at least a component in a direction parallel to an orientation of the numeric value as displayed on the touch screen.

13. The method of claim 1, wherein the modifying of the second digit value is performed responsive to the second touch input having at least a component in a direction perpendicular to an orientation of the numeric value as displayed on the touch screen.

14. The method of claim 13, wherein responsive to an orientation of the numeric value along the display being horizontal, modifying the second digit value comprises increasing the second digit value responsive to the direction of the second touch input being upwards and decreasing the second digit value responsive to the direction of the second touch input being downwards.

15. The method of claim 1, wherein a touch input is one of a swiping motion, a dragging motion, or a flicking motion.

16. A system for modifying a numeric value using a touch screen of a computing device, the system comprising:
a computer processor; and
a computer-readable storage medium storing computer program modules configured to execute on the computer processor, the computer program modules comprising:
an input/output driver module configured to:
display a numeric value on a touch screen, the numeric value having a plurality of digits;
receive a first touch input having a direction and a magnitude, the first touch input associated with a first digit of the numeric value;
responsive to receiving the first touch input, select a second digit of the numeric value, wherein a relative position of the second digit with respect to the first digit is determined based on the magnitude and direction of the first touch input;
receive a second touch input having a direction and a magnitude; and
responsive to receiving the second touch input, modify the value of the second digit based on the second touch input.

17. A computer program product having a computer-readable storage medium storing computer-executable code for modifying a numeric value using a touch screen of a computing device, the code comprising:
an input/output driver module configured to:
display a numeric value on a touch screen, the numeric value having a plurality of digits;
receive a first touch input having a direction and a magnitude, the first touch input associated with a first digit of the numeric value;
responsive to receiving the first touch input, select a second digit of the numeric value, wherein a relative position of the second digit with respect to the first digit is determined based on the magnitude and direction of the first touch input;
receive a second touch input having a direction and a magnitude; and
responsive to receiving the second touch input, modify the value of the second digit based on the second touch input.

18. A method for modifying numeric values via a touch screen, the method comprising:
displaying, by a computer, a numeric value on a touch screen, the numeric value having a first digit and one or more digits that are less-significant compared to the first digit;
receiving a touch input associated with the first digit of the numeric value, the touch input comprising a shake movement associated with the first digit; and
responsive to receiving the touch input, changing the value of each digit of the numeric value having less significance compared to the first digit to a zero value.

19. The method of claim 18, wherein responsive to the touch input, the value of the first digit is incremented by one responsive to the numeric value of the less-significant digits exceeding a threshold value.

20. The method of claim 18, wherein responsive to the touch input, the value of the first digit is incremented by one responsive to the numeric value of a less-significant digit adjacent to the first digit exceeding five.

21. The method of claim 18, wherein the shake input comprises repeated movements comprising:
movement along a first direction followed by movement along a second direction opposite the first direction.

22. The method of claim 21, wherein the first direction of the shake input is along a direction having at least a component perpendicular to a direction of orientation of the numeric value as displayed on a display screen.
